(19) United States
(12) Patent Application Publication
(10) Pub. No.: US 2020/0218760 A1
(43) Pub. Date: Jul. 9, 2020

(54) MUSIC SEARCH METHOD AND DEVICE, SERVER AND COMPUTER-READABLE STORAGE MEDIUM

(71) Applicant: Baidu Online Network Technology (Beijing) Co., Ltd., Beijing (CN)

(72) Inventors: Hong SU, Beijing (CN); Peng WANG, Beijing (CN); Shiquan YE, Beijing (CN)

(73) Assignee: Baidu Online Network Technology (Beijing) Co., Ltd., Beijing (CN)

(21) Appl. No.: 16/700,167

(22) Filed: Dec. 2, 2019

(30) Foreign Application Priority Data
Jan. 3, 2019 (CN) 201910005366.0

(51) Int. Cl. G06F 16/68; G06F 16/638; G06F 16/635

(52) U.S. Cl. CPC G06F 16/686; G06F 16/637; G06F 16/639

(57) ABSTRACT

The embodiments provide a music search method and device, a server and a computer-readable storage medium. The method includes: receiving a search condition from a client terminal; searching for a music tag according to the search condition; acquiring a music list according to the music tag, wherein the music list comprises at least one music identifier; sending a music search request to a third party, wherein the music search request comprises the music list; and receiving from the third party at least one piece of music acquired according to the music identifier in the music list.

### CROSS-REFERENCE TO RELATED APPLICATION

This application claims priority to Chinese Patent Application No. 201910005366.0, entitled “Music Search Method and Device, Server and Computer-Readable Storage Medium”, and filed on Jan. 3, 2019, which is hereby incorporated by reference in its entirety.

### TECHNICAL FIELD

The disclosure relates to the field of the Internet, and more particularly to a music search method and device, a server and a computer-readable storage medium.

### BACKGROUND

With a rapid development of Internet technologies, demands for music have been increasingly grown, and accordingly, requirements for music search have also been increased. Music search includes a specific requirement search and a generic requirement search. An example of the specific requirement search is performing a search according to a search condition “songs of Jay Chou”, and an example of the generic requirement search is performing a search according to a search condition “play relaxing music”. For various reasons such as a music copyright, music resources are usually acquired by cooperating with a third party (for example, QQMusic and Kuwo Music). For example, a Pulse Code Modulation (PCM) audio stream for playing music may be acquired from a music Application (APP) of the third party. Generally speaking, during the specific requirement search, a result returned by the third party is usually relatively accurate and can meet requirements of a user. However, during the generic requirement search, a result returned by the third party is usually not so desirable, which greatly reduces user experience.

### SUMMARY

A music search method and device, a server and a computer-readable storage medium are provided according to embodiments of the disclosure, to solve one or more technical problems in existing technologies.

According to a first aspect, a music search method is provided according to the embodiments of the disclosure, which may include:

receiving a search condition from a client terminal;

searching for a music tag according to the search condition;

acquiring a music list according to the music tag, wherein the music list comprises at least one music identifier;

sending a music search request to a third party, wherein the music search request comprises the music list; and

receiving from the third party at least one piece of music acquired according to the at least one music identifier in the music list.

In an implementation, the method may further include:

determining at least one music tag for a piece of music according to music metadata, wherein the music tag is associated with the music identifier.

In an implementation, the method may further include:

synchronizing music metadata of the third party to a local server.

In an implementation, the method may further include:

according to the music tag of a piece of music, acquiring a collection number of the piece of music from the third party, wherein the collection number indicates a number of music lists including the piece of music in the third party; and

determining an accuracy of the at least one music tag of the piece of music according to the collection number of the piece of music.

In an implementation, the acquiring the music list according to the music tag includes:

acquiring the music list according to the music tag and a user profile.

In an implementation, the method may further includes:

generating the user profile according to historical data of a user on music playing.

According to a second aspect, a music search device is provided according to the embodiments of the disclosure, the device including:

a first receiving module configured to receive a search condition from a client terminal;

a searching module configured to search for a music tag according to the search condition;

an acquiring module configured to acquire a music list according to the music tag, wherein the music list comprises at least one music identifier;

a sending module configured to send a music search request to a third party, wherein the music search request comprises the music list; and

a second receiving module configured to receive from the third party at least one piece of music acquired according to the at least one music identifier in the music list.

In an implementation, the device may further include:

a first determining module configured to determine at least one music tag for a piece of music according to music metadata, wherein the music tag is associated with the music identifier.

In an implementation, the device may further include:

a synchronizing module configured to synchronize music metadata of the third party to a local server.

In an implementation, the device may further include:

a second determining module configured to, according to the music tag of a piece of music, acquire a collection number of the piece of music from the third party; and determine an accuracy of the at least one music tag of the piece of music according to the collection number of the piece of music, wherein the collection number indicates a number of music lists including the piece of music in the third party.

In an implementation, the acquiring module may further be configured to:

acquire the music list according to the music tag and a user profile.

In an implementation mod, the device may further include:

a generating module configured to generate the user profile according to historical data of a user on music playing.

According to a third aspect, a server is provided according to the embodiments of the disclosure. The functions of the server may be implemented by hardware, or by hardware executing corresponding software. The hardware or software includes one or more modules corresponding to the above functions.

In a possible embodiment, the structure of the server includes a processor and a storage, the storage is configured to store a program for supporting the above method according to the first aspect, executed by the server, and the processor is configured to execute the program stored in the storage. The server further includes a communication interface configured for communication between the server and another apparatus or communication network.

According to a fourth aspect, a computer-readable storage medium is provided according to the embodiments of the disclosure, for storing computer software instructions used by the device in the second aspect, the computer software instructions include programs involved in execution of the above method in the first aspect.

One of the technical solutions has the following advantages or beneficial effects.

The music is searched for according to a music tag, so that music search requirements of a user can be met by effective use of music resources of the third party, and particularly, a generic requirement search of the user can be better implemented.

Another technical solution has the following advantages or beneficial effects.

The collection number of a piece of music is acquired from the third party according to each tag of the piece of music, and an accuracy of each tag of the piece of music is determined according to the acquired collection number. With this technical solution, a searching accuracy can be further improved, thereby improving the user experience.

The above summary is for the purpose of the specification only and is not intended to be limiting in any way. In addition to the illustrative aspects, embodiments, and features described above, further aspects, embodiments, and features of the present application will be readily understood by reference to the drawings and the following detailed description.

### BRIEF DESCRIPTION OF DRAWINGS

In the drawings, unless otherwise specified, identical reference numerals will be used throughout the drawings to refer to identical or similar parts or elements. The drawings are not necessarily drawn to scale. It should be understood that these drawings depict only some embodiments disclosed in accordance with the present application and are not to be considered as limiting the scope of the present application.

FIG. 1 is a flowchart of a music search method according to an embodiment of the disclosure.

FIG. 2 is a flowchart of a music search method according to an embodiment of the disclosure.

FIG. 3 is a flowchart of a music search method according to an embodiment of the disclosure.

FIG. 4 is a flowchart of a music search method according to an embodiment of the disclosure.

FIG. 5 is an application diagram of a music search method according to an embodiment of the disclosure.

FIG. 6 is a structure block diagram of a music search device according to an embodiment of the disclosure.

FIG. 7 is a structure block diagram of a music search device according to an embodiment of the disclosure.

FIG. 8 is a structure block diagram of a music search device according to an embodiment of the disclosure.

FIG. 9 is a structure block diagram of a music search device according to an embodiment of the disclosure.

FIG. 10 is a structure block diagram of a music search device according to an embodiment of the disclosure.

FIG. 11 is a structure block diagram of a server according to an embodiment of the disclosure.

### DETAILED DESCRIPTION

In the following, only certain exemplary embodiments are briefly described. As those skilled in the art would realize, the described embodiments may be modified in various different ways, all without departing from the spirit or scope of the present application. Accordingly, the drawings and description are to be regarded as illustrative in nature and not restrictive.

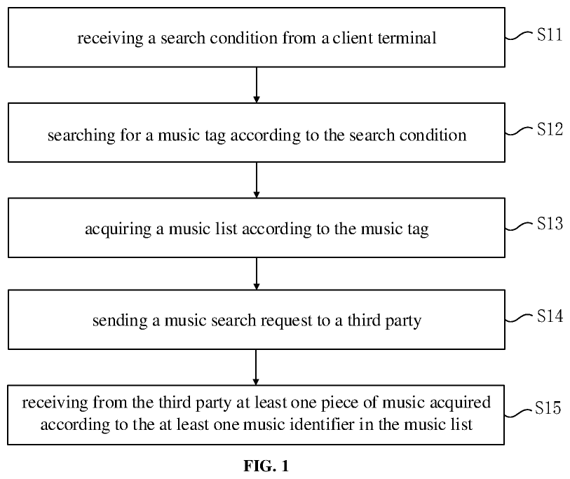

FIG. 1 is a flowchart of a music search method according to an embodiment of the disclosure. As shown in FIG. 1, the music search method includes steps S11 to S15.

In S11, a search condition from a client terminal is received.

In S12, a music tag is searched for according to the search condition.

In S13, a music list is acquired according to the music tag, wherein the music list includes at least one music identifier.

In S14, a music search request is sent to a third party, wherein the music search request includes the music list.

In S15, at least one piece of music acquired according to the at least one music identifier in the music list is received from the third party.

In a specific implementation, the client terminal may include a personal computer, a mobile phone, a notebook computer and a Personal Digital Assistant (PDA), etc.

When a music search is issued from the client terminal, a music resource is acquired through a server or a cooperating third party. For various reasons such as a music copyright, more music resources are acquired by cooperating with the third party (for example, QQMusic and Kuwo Music). The third party may include a cooperating party APP possessing a music copyright on the music resource, and the user may search for and acquire music data through the APP.

The search condition from the client terminal may include, but not limited to, a text, a voice and an image, etc. During the music search, the most commonly-used music search manner is using a text. For example, a text is input into a search box to acquire music. However, with the continuous development of Internet technologies and gradual increase of requirements on search convenience, there have been more and more APPs on voice search. For example, a speech such as “songs of XXX” or “play relaxing songs” is input for performing a search. In addition, a search may also be implemented through an image. For example, an album cover of a singer, etc. is uploaded for searching. In the above searching manners, music may be searched for by extracting a keyword from the search condition.

In a practical music search process, when the user performs a specific requirement search, a result returned by the third party is usually relatively accurate. For example, “songs of XXX” is input by using a speech as the search condition, where XXX is a name of a certain star.

However, when the user performs a generic requirement search, a song list result returned by the third party is usually not so desirable. For example, when the user inputs “play relaxing songs” by voice, a song list returned by the third party may not only include relaxing songs but also include songs with the word “relaxing” included in the names of the songs. Such a result for the generic search is greatly different from a target of the user, so that the user experience is greatly affected. With the technical solution of the embodiment of the disclosure, at least one piece of music is searched for through a tag of the piece of music, so that user requirements on music search can be met by effective use of music resources of the third party. Particularly, a generic requirement search of the user may be better implemented.

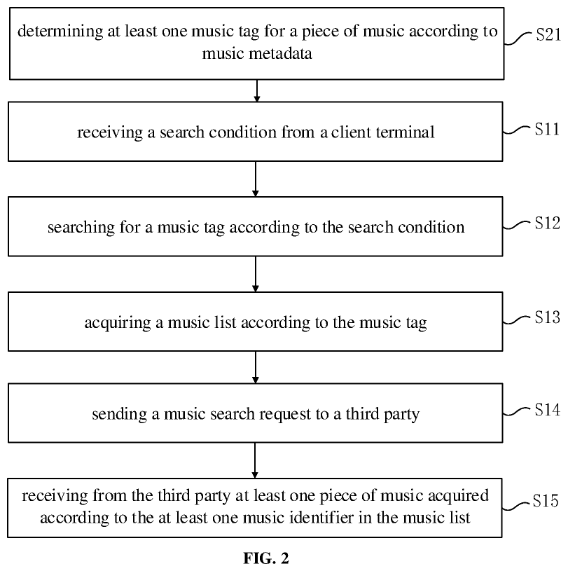

In an implementation, as shown in FIG. 2, the method further includes step S21.

In S21, at least one music tag is determined for a piece of music according to music metadata, wherein the music tag is associated with the music identifier. The music tag may include a name, an album, a year, a type and a songwriter, etc. of the piece of music. On one hand, a piece of music may include multiple music tags. On another hand, multiple pieces of music may also be provided with an identical music tag. A music tag for a piece of music may be determined by a manual manner or an automatic manner such as by a computer. In an implementation, the music tag may be stored in a local server. It can be seen from the example music tag that a name and a type of a piece of music may be determined by the music tag and thus the music tag may be used for distinguishing pieces of music during the generic requirement search, thereby greatly improving the user experience.

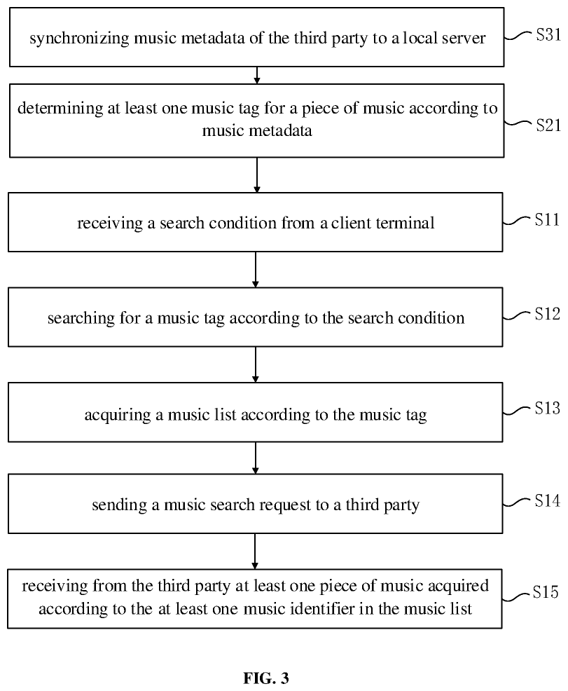

In an implementation, as shown in FIG. 3, the method further includes the step S31.

In S31, the music metadata of the third party is synchronized to a local server. The music metadata may include information such as a music identifier, a name, an album, an artist, a year, a type and a songwriter of a piece of a music. In an implementation, the metadata of the third party may be stored in the local server. Synchronizing the music metadata of the third party to the local server may be used to determine a more accurate music tag for a piece of music from the third party (the music of the third party may contain the music tag by itself), thereby improving the search accuracy.

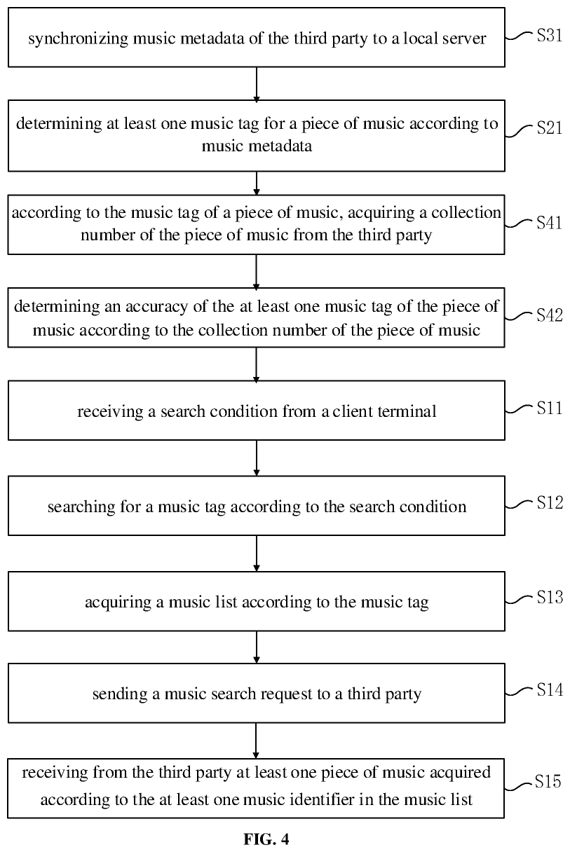

In an implementation, as shown in FIG. 4, the method further includes S41 and S42.

In S41, according to the music tag of a piece of music, a collection number of the piece of music from the third party is acquired, wherein the collection number indicates a number of music lists including the piece of music in the third party.

In S42, an accuracy of the at least one music tag of the piece of music is determined according to the collection number of the piece of music.

To determine the accuracy of the music tag of a piece of music, reference may be made to related information of the third party. For example, if the collection number of a piece of music for a certain music tag is relatively high in the third party, it is indicated that the music tag for the piece of music in the local server is accurate. For another example, if the collection number of a piece of music is relatively low for a certain music tag in the third party, it is indicated that the music tag of the piece of music in the local server is inaccurate. In a specific implementation, the determining may be performed by setting an accuracy threshold. When the collection number is more than or equal to the accuracy threshold, it is determined that the music tag is accurate.

In an implementation, the method further includes the following step.

A user profile is generated according to historical data of a user on music playing.

Behavioral data of the user on music playing can be abstracted to obtain a user attribute tag, and features of the user may be described in detail with the user attribute tag as the user profile, thereby providing targeted service for the user. Specifically, the historical data may include historical search information, collection information, music playing mode (for example, single cycle) and music playing frequency, etc. of the user.

In an implementation, acquiring the music list according to the music tag is performed by:

acquiring the music list according to the music tag and the user profile. For example, when the user performs a search by a search condition “relaxing songs”, if an attribute tag in the user profile is “English songs”, more English relaxing songs may be returned to the user, thereby improving the user experience.

In an application example, a cloud server synchronizes music metadata from a third party locally through a third party APP, and then at least one music tag for each piece of music is determined according to the music metadata, wherein the music tag is associated with a music identifier. A piece of music may be provided with multiple tags, and multiple pieces of music may be provided with an identical tag. The server may further acquire a collection number of the piece of music from the third party according to each music tag of the piece of music and determine an accuracy of each music tag according to the collection number.

A user profile may further be generated by the server for each user according to historical data. For example, if there are much English songs in a search history of the user, the user profile of the user includes an attribute tag “English song”. Then, when the user performs a music search, the server may acquire a music list according to the music tag along with the user profile.

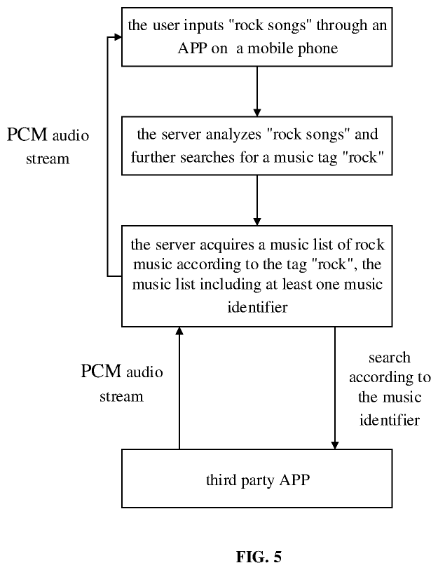

As shown in FIG. 5, the user sends a music search request to the server through an APP on a terminal device such as a mobile phone. For example, the user inputs “rock songs” by voice.

The server, after receiving the search request “rock songs”, analyzes the search request and obtains a keyword “rock” from the music search request, and further searches for a music tag “rock” according to the keyword “rock”. The server acquires a music list of rock music according to the tag “rock”, the music list including at least one music identifier. The server sends a music search request to the third party APP, the music search request including the music list of the rock music. The third party APP, after receiving the music list of the rock music, performs a search and returns a PCM audio stream of the rock music according to the music identifier therein. The server sends the received PCM audio stream of the rock music to the APP on the mobile phone of the user.

The server may further send a music search request including “rock” and “English song” to the third party APP according to the attribute tag “English song” in the user profile, the music search request including a music list of English rock songs. The third party APP, after receiving the music list of the English rock songs, performs a music search and returns an audio stream of at least one English rock song according to a music identifier therein. The server sends the received audio stream of the English rock song to the APP on the mobile phone of the user.

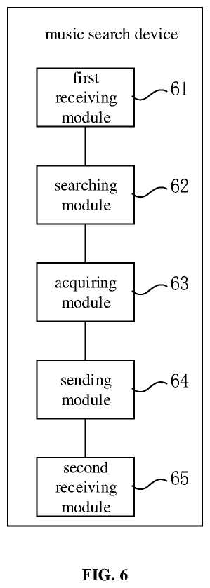

FIG. 6 is a structure block diagram of a music search device according to an embodiment of the disclosure. As shown in FIG. 6, the device may include:

a first receiving module 61 configured to receive a search condition from a client terminal;

a searching module 62 configured to search for a music tag according to the search condition;

an acquiring module 63 configured to acquire a music list according to the music tag, wherein the music list comprises at least one music identifier;

a sending module 64 configured to send a music search request to a third party, wherein the music search request comprises the music list; and

a second receiving module 65 configured to receive from the third party at least one piece of music acquired according to the at least one music identifier in the music list.

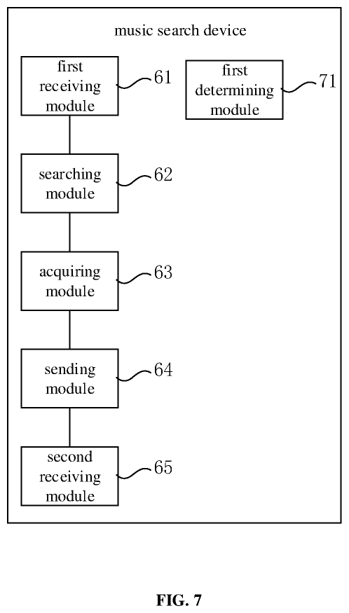

In an implementation, as shown in FIG. 7, the device further includes:

a first determining module 71 configured to determine at least one music tag for a piece of music according to music metadata, wherein the music tag is associated with the music identifier.

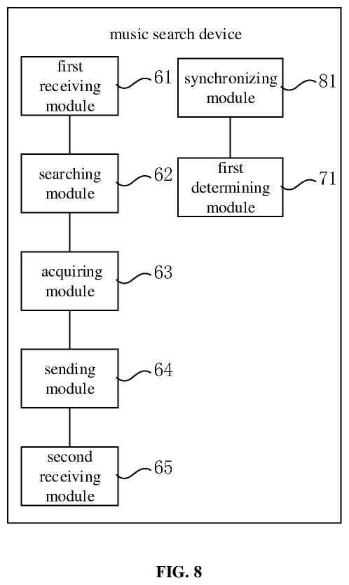

In an implementation, as shown in FIG. 8, the device further includes:

a synchronizing module 81 configured to synchronize music metadata of the third party to a local server.

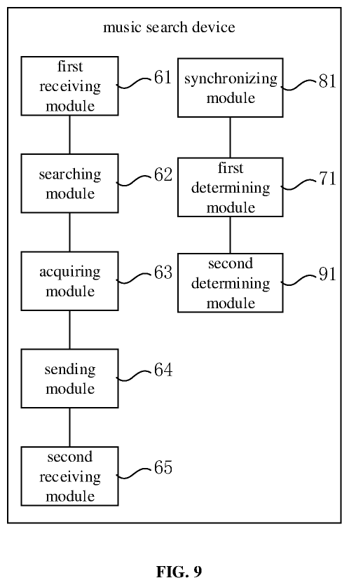

In an implementation, as shown in FIG. 9, the device further includes:

a second determining module 91 configured to, according to the music tag of a piece of music, acquire a collection number of the piece of music from the third party; and determine an accuracy of the at least one music tag of the piece of music according to the collection number of the piece of music, wherein the collection number indicates a number of music lists including the piece of music in the third party.

In an implementation, the acquiring module may further be configured to: acquire the music list according to the music tag and a user profile.

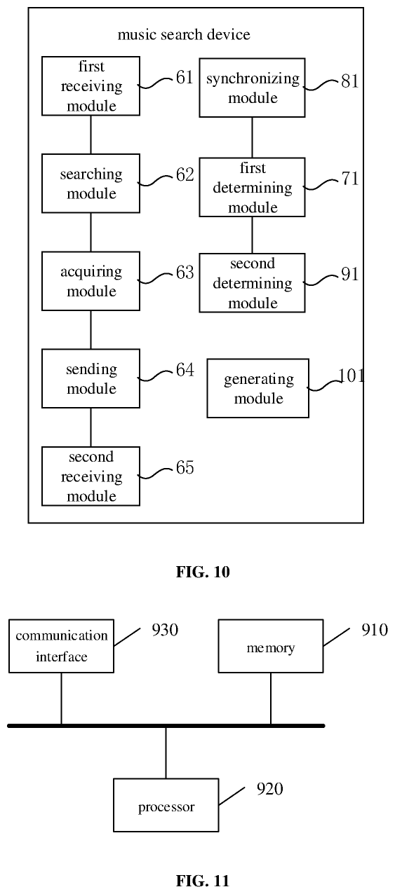

In an implementation, as shown in FIG. 10, the device further includes:

a generating module 101 configured to generate the user profile according to historical data of a user on music playing.

In this embodiment, functions of modules in the device refer to the corresponding description of the above mentioned method and thus the description thereof is omitted herein.

FIG. 11 is a structure block diagram of a server according to an embodiment of the disclosure. As shown in FIG. 11, the server includes a memory 910 and a processor 920. The memory 910 stores a computer program executable on the processor 920. When the processor 920 executes the computer program, the method for processing an audio signal in a vehicle in the foregoing embodiment is implemented. The number of the memory 910 and the processor 920 may be one or more.

The server further includes a communication interface 930 configured to communicate with an external device and exchange data.

The memory 910 may include a high-speed RAM memory and may also include a non-volatile memory, such as at least one magnetic disk memory.

If the memory 910, the processor 920, and the communication interface 930 are implemented independently, the memory 910, the processor 920, and the communication interface 930 may be connected to each other through a bus and communicate with one another. The bus may be an Industry Standard Architecture (ISA) bus, a Peripheral Component (PCI) bus, an Extended Industry Standard Component (EISA) bus, or the like. The bus may be divided into an address bus, a data bus, a control bus, and the like. For ease of illustration, only one bold line is shown in FIG. 11 but it does not mean that there is only one bus or one type of bus.

Optionally, in a specific implementation, if the memory 910, the processor 920, and the communication interface 930 are integrated on one chip, the memory 910, the processor 920, and the communication interface 930 may implement mutual communication through an internal interface.

According to an embodiment of the present application, a computer-readable storage medium is provided for storing computer software instructions, which include programs involved in execution of the above the method.

In the description of the specification, the description of the terms “one embodiment,” “some embodiments,” “an example,” “a specific example,” or “some examples” and the like means the specific features, structures, materials, or characteristics described in connection with the embodiment or example are included in at least one embodiment or example of the present application.

Furthermore, the specific features, structures, materials, or characteristics described may be combined in any suitable manner in any one or more of the embodiments or examples. In addition, different embodiments or examples described in this specification and features of different embodiments or examples may be incorporated and combined by those skilled in the art without mutual contradiction.

In addition, the terms “first” and “second” are used for descriptive purposes only and are not to be construed as indicating or implying relative importance or implicitly indicating the number of indicated technical features. Thus, features defining “first” and “second” may explicitly or implicitly include at least one of the features. In the description of the present application, “a plurality of” means two or more, unless expressly limited otherwise.

Any process or method descriptions described in flowcharts or otherwise herein may be understood as representing modules, segments or portions of code that include one or more executable instructions for implementing the steps of a particular logic function or process. The scope of the preferred embodiments of the present application includes additional implementations where the functions may not be performed in the order shown or discussed, including according to the functions involved, in substantially simultaneous or in reverse order, which should be understood by those skilled in the art to which the embodiment of the present application belongs.

Logic and/or steps, which are represented in the flowcharts or otherwise described herein, for example, may be thought of as a sequencing listing of executable instructions for implementing logic functions, which may be embodied in any computer-readable medium, for use by or in connection with an instruction execution system, device, or apparatus (such as a computer-based system, a processor-included system, or other system that fetch instructions from an instruction execution system, device, or apparatus and execute the instructions). For the purposes of this specification, a “computer-readable medium” may be any device that may contain, store, communicate, propagate, or transport the program for use by or in connection with the instruction execution system, device, or apparatus. More specific examples (not a non-exhaustive list) of the computer-readable media include the following: electrical connections (electronic devices) having one or more wires, a portable computer disk cartridge (magnetic device), random access memory (RAM), read only memory (ROM), erasable programmable read only memory (EPROM or flash memory), optical fiber devices, and portable read only memory (CDROM). In addition, the computer-readable medium may even be paper or other suitable medium upon which the program may be printed, as it may be read, for example, by optical scanning of the paper or other medium, followed by editing, interpretation or, where appropriate, process otherwise to electronically obtain the program, which is then stored in a computer memory.

It should be understood that various portions of the present application may be implemented by hardware, software, firmware, or a combination thereof. In the above embodiments, multiple steps or methods may be implemented in software or firmware stored in memory and executed by a suitable instruction execution system. For example, if implemented in hardware, as in another embodiment, they may be implemented using any one or a combination of the following techniques well known in the art: discrete logic circuits having a logic gate circuit for implementing logic functions on data signals, application specific integrated circuits with suitable combinational logic gate circuits, programmable gate arrays (PGA), field programmable gate arrays (FPGAs), and the like.

Those skilled in the art may understand that all or some of the steps carried in the methods in the foregoing embodiments may be implemented by a program instructing relevant hardware. The program may be stored in a computer-readable storage medium, and when executed, one of the steps of the method embodiment or a combination thereof is included.

In addition, each of the functional units in the embodiments of the present application may be integrated in one processing module, or each of the units may exist alone physically, or two or more units may be integrated in one module. The above-mentioned integrated module may be implemented in the form of hardware or in the form of software functional module. When the integrated module is implemented in the form of a software functional module and is sold or used as an independent product, the integrated module may also be stored in a computer-readable storage medium. The storage medium may be a read only memory, a magnetic disk, an optical disk, or the like.

The foregoing descriptions are merely specific embodiments of the present application, but not intended to limit the protection scope of the present application. Those skilled in the art may easily conceive of various changes or modifications within the technical scope disclosed herein, all these should be covered within the protection scope of the present application. Therefore, the protection scope of the present application should be subject to the protection scope of the claims.

1. A music search method, comprising:
receiving a search condition from a client terminal;
searching for a music tag according to the search condition;
acquiring a music list according to the music tag, wherein the music list comprises at least one music identifier;
sending a music search request to a third party, wherein the music search request comprises the music list; and
receiving from the third party at least one piece of music acquired according to the at least one music identifier in the music list.

2. The music search method of claim 1, further comprising:
determining at least one music tag for a piece of music according to music metadata, wherein the music tag is associated with the music identifier.

3. The music search method of claim 1, further comprising:
synchronizing music metadata of the third party to a local server.

4. The music search method of claim 2, further comprising:
according to the music tag of a piece of music, acquiring a collection number of the piece of music from the third party, wherein the collection number indicates a number of music lists including the piece of music in the third party; and
determining an accuracy of the at least one music tag of the piece of music according to the collection number of the piece of music.

5. The music search method of claim 1, wherein acquiring the music list according to the music tag comprises:
acquiring the music list according to the music tag and a user profile.

6. The music search method of claim 5, further comprising:
generating the user profile according to historical data of a user on music playing.

7. A music search device, comprising:
one or more processors; and
a non-transitory storage device configured for storing computer executable instructions, wherein
the computer executable instructions are executed by the one or more processors to enable the one or more processors to:
receive a search condition from a client terminal;
search for a music tag according to the search condition;
acquire a music list according to the music tag, wherein the music list comprises at least one music identifier;
send a music search request to a third party, wherein the music search request comprises the music list; and
receive from the third party at least one piece of music acquired according to the at least one music identifier in the music list.

8. The music search device of claim 7, wherein the computer executable instructions are executed by the one or more processors to enable the one or more processors further to:
determine at least one music tag for a piece of music according to music metadata, wherein the music tag is associated with the music identifier.

9. The music search device of claim 7, wherein the computer executable instructions are executed by the one or more processors to enable the one or more processors further to:
synchronize music metadata of the third party to a local server .

10. The music search device of claim 7, wherein the computer executable instructions are executed by the one or more processors to enable the one or more processors further to:
according to the music tag of a piece of music, acquire a collection number of the piece of music from the third party, wherein the collection number indicates a number of music lists including the piece of music in the third party; and
determine an accuracy of the at least one music tag of the piece of music according to the collection number of the piece of music.

11. The music search device of claim 7, wherein the computer executable instructions are executed by the one or more processors to enable the one or more processors further to: acquire the music list according to the music tag and a user profile.

12. The music search device of claim 11, wherein the computer executable instructions are executed by the one or more processors to enable the one or more processors further to:
generate the user profile according to historical data of a user on music playing.

13. A non-transitory computer-readable storage medium, storing computer executable instructions stored thereon, that when executed by a processor cause the processor to perform operations comprising:
receiving a search condition from a client terminal;
searching for a music tag according to the search condition;
acquiring a music list according to the music tag, wherein the music list comprises at least one music identifier;
sending a music search request to a third party, wherein the music search request comprises the music list; and
receiving from the third party at least one piece of music acquired according to the at least one music identifier in the music list.
